(19) United States
(12) Patent Application Publication
(10) Pub. No.: US 2009/0282368 A1
(43) Pub. Date: Nov. 12, 2009

(54) User Interface for Accessing Lists

(75) Inventors: Wilfred Lam, Los Altos, CA (US); Rakesh Ramde, Saratoga, CA (US)

Correspondence Address: JAS IP CONSULTING, 309 2nd STREET, SUITE 8, LOS ALTOS, CA, 94022, US

(73) Assignee: INNOVATION MANAGEMENT SCIENCES, LLC, Mountain View, CA (US)

(21) Appl. No.: 12/121,005

(22) Filed: May 15, 2008

Related U.S. Application Data
(60) Provisional application No. 60/931,062, filed on May 21, 2007.

(51) Int. Cl. G06F 3/048; G06F 7/06; G06F 17/30

(52) U.S. Cl. 715/834; 715/823; 707/3; 707/E17.107

(57) ABSTRACT

A consistent method of navigating across large data sets, particularly search results from search engines and play lists from media player devices is disclosed. Persistent navigation position markers provide the user with indication of current position in the data set. By using a click wheel which is provided on many mobile communication platforms, personal digital assistants and the like, simple operation is provided. Alternatively, a touch pad, touch screen and stylus, or thumb mouse may be used.

### CROSS-REFERENCE TO RELATED APPLICATIONS

The present invention is related to and claims priority from copending U.S. Provisional Application titled “User Interface for Accessing Lists”, Ser. No. 60/931,062, filed on May 21, 2007, and further which, in its entirety, is incorporated herein by reference.

### BACKGROUND

The present invention relates to a user interface for display and navigation of a multitude of text listings, particularly to viewing search results linked to web pages or web based media.

As more data such as listings and search results are readily available on the Web, the manner in which they are presented for viewing limits the amount of data that may be consumed by a user at one time. As browsing listings such as text data and pictures have become increasingly popular, the display size has not adequately changed to keep pace. Specifically, search result items are generally presented as blocks of text in a single page format with multiple web pages or the like in which each page may contain text, images, and graphics annotations. Image media are embodied by file types such as JPEG, GIF, TIF, BMP, and the like although each search result item may include any type of graphic or text rendering. Each block of text or data element generally contains at least one hyperlink which enables user navigation to another web page containing additional data related to that data element.

As portable devices become an increasingly popular vehicle for accessing data, the problem of display size becomes more exaggerated. Portable device browsers attempt to contend with the display size limitation by accessing web pages that are specifically designed for such devices. Although these abbreviated formats account for display size and resolution limitations, search results still extend far beyond the capability of the screen preventing viewing of any more than a very small portion of the available data. Furthermore, interface conventions demand that text data is formatted in smaller font size, thus decreasing legibility. Therefore page formats, user interface and navigation means become an increasingly significant part of the solution for improving the user experience.

To break up data presentation into pieces, pages are defined in a number of ways. Typically they are a single view presented in a web browser that may contain links to navigate to other pages. One web page is delineated from another by a rendered change of view and new data presented when another page is selected, replacing the previous page. Within this single 2D format view, a larger page may be extended beyond the visible portion of the screen. For such larger pages, a scroll bar supports visual access to the remaining portions. Alternatively, pages may be delineated by regular breaks in color and formatting between rectangular regions presented, and providing controls to move from one page to the next, analogous to the pages of a book.

Conventional navigation between pages is accomplished by a point and click method, selecting hyperlinks from one page to another. Navigation within a page is accomplished using a scroll bar. Each method differs from the other resulting in a non-contiguous method of navigating data elements from a data set. For example, when the first page is loaded and partially displayed, a user is required to scroll down the page to view all portions. Scrolling may require clicking on a browser's scroll bar and dragging it downward using a pointer device such as a mouse, a stylus, or a scroll wheel. Once at the bottom of the page, the user is next required to point and click on a link to request the next page from the corresponding hosting web server. Upon loading and rendering the next web page for display, the user repeats the aforementioned operations for that page.

If a user chooses to click on a data element's hyperlink, then this method typically differs from the other two methods of navigating within the data set. Therefore, the user is required to vary between three methods to navigate across data elements and click through a data element (traverse a data element hyperlink).

In another method of navigation, a keyboard or set of keys may be used to replace or augment the pointer operations. For example, PAGE DOWN or ARROW keys become the vehicle of navigation across search result items and their web pages. The ENTER key or the like replaces the select operation of a pointer device's left mouse button down event. However, this method also suffers from the same shortcomings. First, advancing through and returning to search result items requires the user to switch between two methods of advancing, scrolling and clicking. Second, both methods of navigation typically lack a means of persistently displaying an indication of the relative position of a current data element within the set of all data.

In one embodiment of the prior art, the relative position of a data element within a data set is indicated on its web page by the relative position of the browser's scroll bar. The relative position of the Web page with respect to the entire set of web pages containing the data set is indicated by a page number within a range of page numbers. Typically, the page number only appears at the bottom and optionally at the top of each web page. Page numbers are typically hyperlinked to the corresponding page providing an alternative random selection method beyond a hyperlinked “NEXT PAGE” indicator.

Therefore, the prior art fails to provide a method of consistently and continuously navigating across and through data elements and web pages without switching methods. Furthermore, the prior art fails to provide a persistent means of displaying the relative position of a data element within the entire set of data elements. The result is a cumbersome exchange between navigation methods without an ongoing representation of the user's relative or absolute position of a current element within a multitude of data elements.

An alternative embodiment of prior art teaches a graphical method comprising a clock face arrangement of a set of buttons referred to herein as a dial. These buttons offer a randomly accessible method of selecting a single search result from a set of search results. The dial has numbered buttons around its circumference and a subject name at its center. As a user's mouse hovers over each button on the dial, a pop-up dialog summarizes that data related to that element. This pop-up dialog contains text and image data. When a user clicks on a button, another instantiation of a browser is launched, displaying the Web page corresponding to the button's hyperlink. It is worth noting that the dial does not turn i.e. the buttons remain stationary on the page.

This method has several shortcomings. First, it fails to enable comprehensive access to all search results. Rather, the method pre-selects a small subset of search results. Second, this method consumes a high degree of display real estate by displaying a plurality of rotary dial interfaces for a single search, popping up search elements across the screen. Also, the method instantiates a new browser window for each data element that is clicked through. Third, the method requires a user to move his mouse over the clock face in an awkward fashion so that each element can be accessed.

In another embodiment of the prior art, Groxis Inc. offers another type of navigation using a dial graphical user interface on their grokker.com web site. Groxis adds a hierarchical feature to their dial interface. For example, when a button on the dial is clicked on or selected, the user interface is re-rendered to represent an animation of traversing downward into either another dial of buttons or a dial of web pages. Therefore the dials are continuously changing as a user traverses links. Similar to that described above, the Groxis method displays a plurality of dials for each search according to subject matter. The Groxis method differs in that the data elements are summarized in traditional search result listing form in a side bar. However, clicking through on any on element also launches a new instantiation of a browser, disadvantageously consuming additional display space.

The click wheel, which is used by some portable devices, is an alternative to conventional pointing devices such as the mouse or trackball. Whereas the mouse provides for the user a two-dimensional movement of a glyph on its display, the click wheel may be used to cyle through all selectable items on a screen. Typically, cycling is carried out in a round robin fashion. Selectable items are highlighted in turn. A highlighted item may be selected by depressing the click wheel. This is equivalent to the left mouse button down event which is the data item selection convention of the mouse. The click wheel therefore provides for the capability of one finger movements for traversal through a data set. However, these devices lack the graphical user interface to move and traverse through a large data set while providing persistent navigation position markers indicating a user's current position in a data set.

### SUMMARY

The present invention provides for a consistent method of navigating across large data sets, particularly search results from search engines and play lists from media player devices. Persistent navigation position markers provide the user with indication of current position in the search results. By using a click wheel which is provided on many mobile communication platforms today, simple (e.g., single finger) operation is provided. Alternatively, a touch pad, touch screen and stylus, or thumb mouse may be used.

It is therefore an aspect of the current invention to provide an interface for accessing search results on a mobile Internet device.

It is also an aspect of the current invention to provide an interface for accessing play lists on a mobile playback device.

It is further an aspect of the current invention to provide a persistent display method of indicating the relative position of a data element within a plurality of data elements.

It is another aspect of the current invention to provide a persistent display method of indicating the absolute position of a data element within a plurality of data elements.

It is further an aspect of the current invention to provide a consistent method of traversing across and through a plurality of data elements using a click wheel.

It is yet another aspect of the current invention to provide a mobile Internet device interface for search engines.

It is further an aspect of the present invention to provide increased legibility and ease of use when browsing search results on a mobile Internet device.

### BRIEF DESCRIPTION OF THE DRAWINGS

In the drawings appended hereto like reference numerals denote like elements between the various drawings. While illustrative, the drawings are not drawn to scale. In the drawings:

FIG. 1 is an embodiment of a user interface for accessing web search results on a mobile Internet device platform according to the present invention.

FIG. 2 is an alternative embodiment of the graphical user interface for a search engine on a mobile Internet device platform according to the present invention.

FIG. 3 is a system diagram of the Web server and mobile Internet device system of the present invention.

FIG. 4 is a flow chart detailing a server based implementation of the user interface of an embodiment according to the present invention.

FIG. 5 is a flow chart detailing a client based mobile Internet device implementation of the user interface of an embodiment according to the present invention.

### DETAILED DESCRIPTION OF THE INVENTION

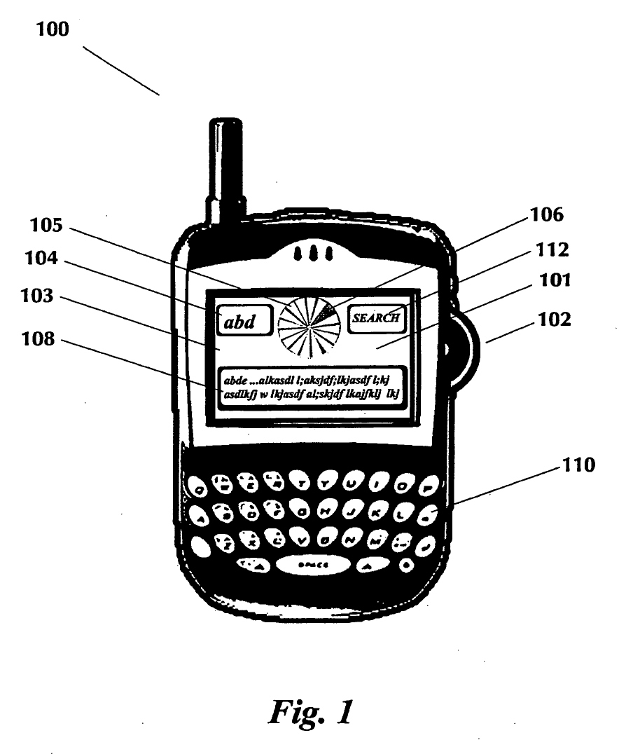

Referring to FIG. 1, an embodiment of a user interface for a search engine on a mobile Internet device (MID) 100 platform is shown. The mobile Internet device may be a general purpose communication device with web capabilities such as a web enabled cell phone, a dedicated portable web browser device, or the like. Primary hardware interface elements of the MID 100 include a display 101, click wheel 102, and a keyboard 110. The click wheel may also be embodied by a touch pad, touch screen stylus, thumb mouse, roller ball, or alternatively a virtual click wheel mounted to the side or to the top of the MID 100 (e.g., as part of a touch screen display). The virtual click wheel may be constructed with the same elements as a conventional touch pad, such as a piezo-electric device or resistive film element for determining position and pressure of a fingertip on its surface. Sliding a fingertip up and down along the touchpad surface emulates the behavior of rotating a click wheel. Tapping or depressing the touchpad emulates the behavior of depressing the click wheel. The virtual click wheel advantageously provides a non-mechanical and a low profile embodiment.

The display 101 shows elements of the graphical user interface 103 or GUI. The GUI 103 may exist as a device specific web browser, a web page within a device's 100 web browser, or an embedded application with the capability to access databases on the Internet. For illustration, assume that the GUI 103 is a web page within the mobile Internet device's 100 browser. The web page is therefore received from a search web site as referenced by the site's corresponding URL.

The GUI 103 includes a search box 104 into which a user types a search string using the keyboard 110. To execute the search, the user then selects the search command button 112 by rotating the click wheel 102 until the button 112 is highlighted. The click wheel 102 is then depressed indicating selection. Upon selection, the mobile Internet device 100 sends a request to the search web site's server as may be indicated in the browser or similar application on which the GUI 103 resides.

When the MID 100 receives search results data from the requested search web site server, it is displayed piecemeal on the device's display 101. The first and subsequent data elements 108 are shown in FIG. 1. According to the present invention, the relative position marker 105 is comprised of a plurality of slices such as a cut pie. The selected slice 106 corresponding to the position of the current data element 108 is highlighted. As the user rotates the click wheel 102, a different slice 106 is highlighted corresponding to a different position in the data set of search results 108. Each search result data element 108 is displayed in turn as the click wheel 102 is rotated. Each data element 108 is typically comprised of text and has associated to it a hyperlink. The hyperlink is a URL that may request a web page, or media such as a song, picture or movie. In such instances, the data elements 108 may be a play list or a list of search results.

One convention of advancing through a data set of search results requires the user to rotate the click wheel 102 in a clockwise fashion. Contiguous slices 106 in the relative position marker 105 are highlighted in turn, also in a clockwise fashion. Corresponding to each granular movement of the click wheel 102 is a stepwise advance to the next data element 108 and the next highlighted selected slice 106. In this manner, the user has both a textual and visual reference to his place in the search results data set.

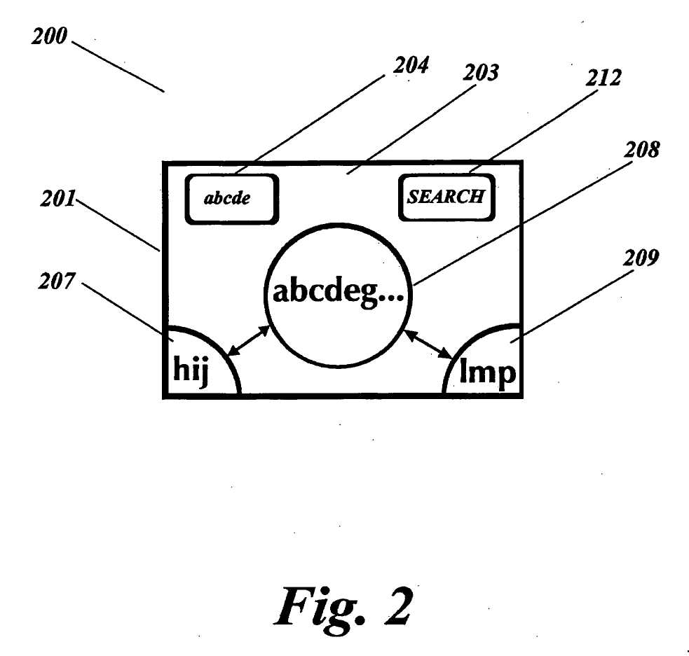

Referring to FIG. 2, an alternative embodiment 200 of the graphical user interface 203 on the mobile Internet device 100 is shown. Like elements include the search box 204 and the search command button 212. The equivalent display elements of FIG. 1, the relative position marker 105, the selected slice 106, and data element 108 are replaced by the current data element 208, previous data element 209, and next data element 207. These data elements (207, 208, and 209) are advanced in unison with rotation of the click wheel 102. With each stepwise advancement of the click wheel 102, the next data element 209 is advanced into the position occupied by the current data element 208. The current data element 208 is advanced into the position occupied by the previous data element 209. The previous data element 207 is removed from the display 101 and a new data element (the data element in the search result data set following the next data element) advances into the position occupied by the next data element 207. In this embodiment, the click wheel 102 may include a relative position indicator (e.g., a notch, a sticker) that indicates to the user the approximate position of the current data element 207 in the set of search results.

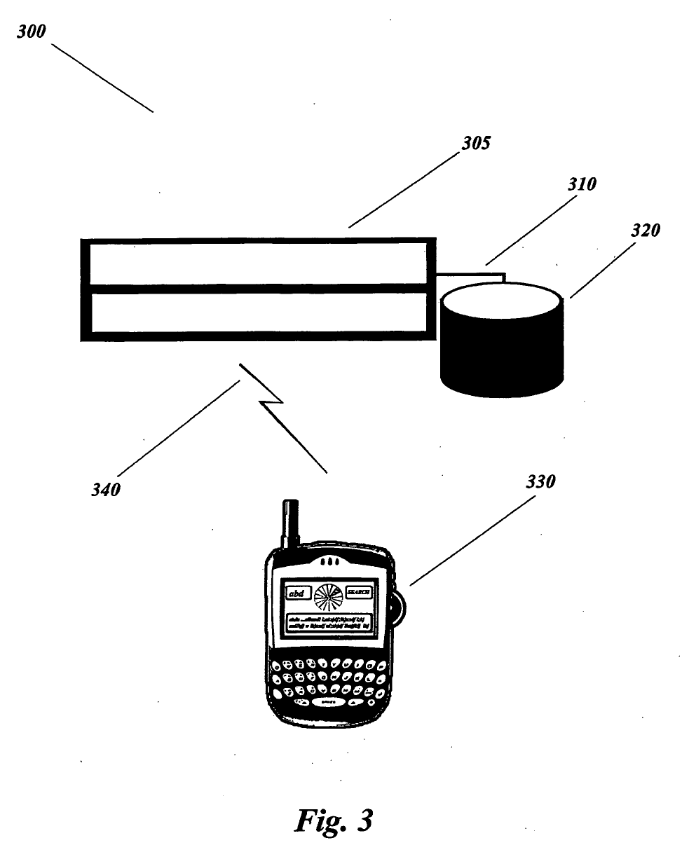

Referring next to FIG. 3, a system diagram 300 of a web server 305 and mobile Internet device 330 is shown. The web server 305 is electrically connected 310 to a database which is searchable by request via Internet connection 340. A mobile Internet device 330 which is also connected to the Internet 340 originates a search request from a user input to that device 330. Data retrieval from the database 320 search request is delivered to the mobile Internet device 330 in the form of formatted web pages or the like so that search results data are readily displayed and navigated.

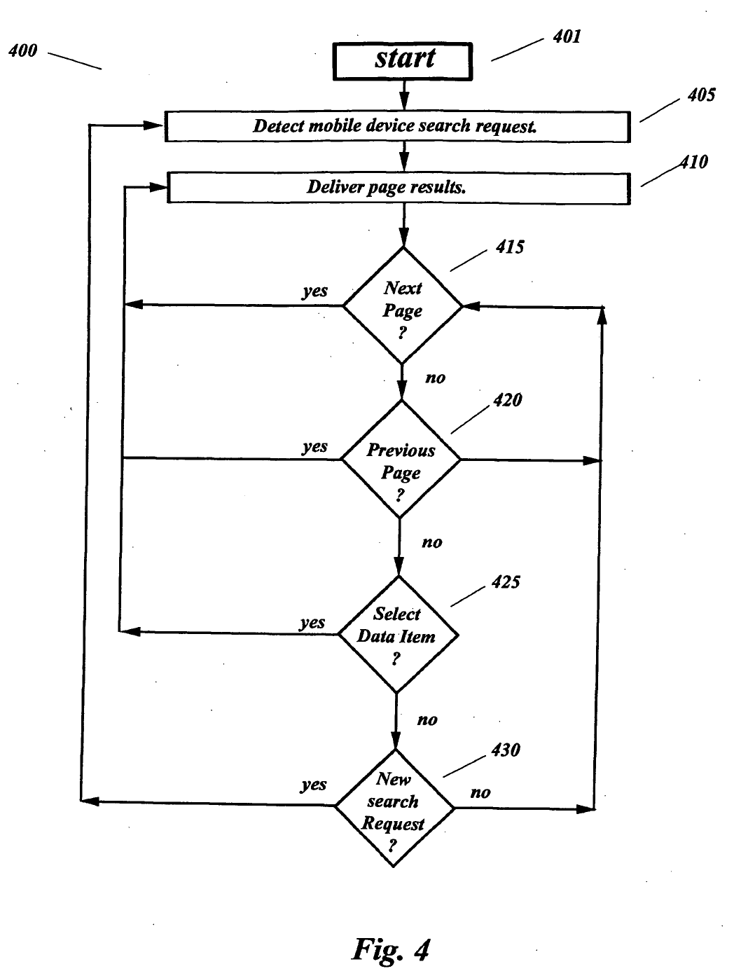

Next, FIG. 4 is a flow chart 400 detailing a server based implementation of the user interface preferred embodiment. The server program begins 401 by first detecting a search request from a mobile Internet device and as such, search results are formatted by the server and delivered to the mobile Internet device and displayed by the device such that the interface described hereinabove is realized. As search results extend well beyond the visible scope of the mobile Internet device display, the data are broken down and delivered in web pages as is well known in the art.

According to user input, next page requests 415 and previous page requests 420 and new search requests 430 are received by the Web server and as a consequence, the server formats and delivers to the mobile Internet device another page. The position marker (e.g., 105, FIG. 1) may represent the number of data elements on a web page by matching the corresponding number of slices of the pie chart, though this is not a requirement. Assuming so for the sake of illustration, it is assumed here that a next page 415 or a previous page 420 will be requested with every complete rotation of selected slices on the position marker. If the current data element is selected 425 or clicked through for traversal, then the page or media data (e.g. audio file, video file, images) corresponding to its hyperlinked URL is requested by the mobile Internet device from the Web server.

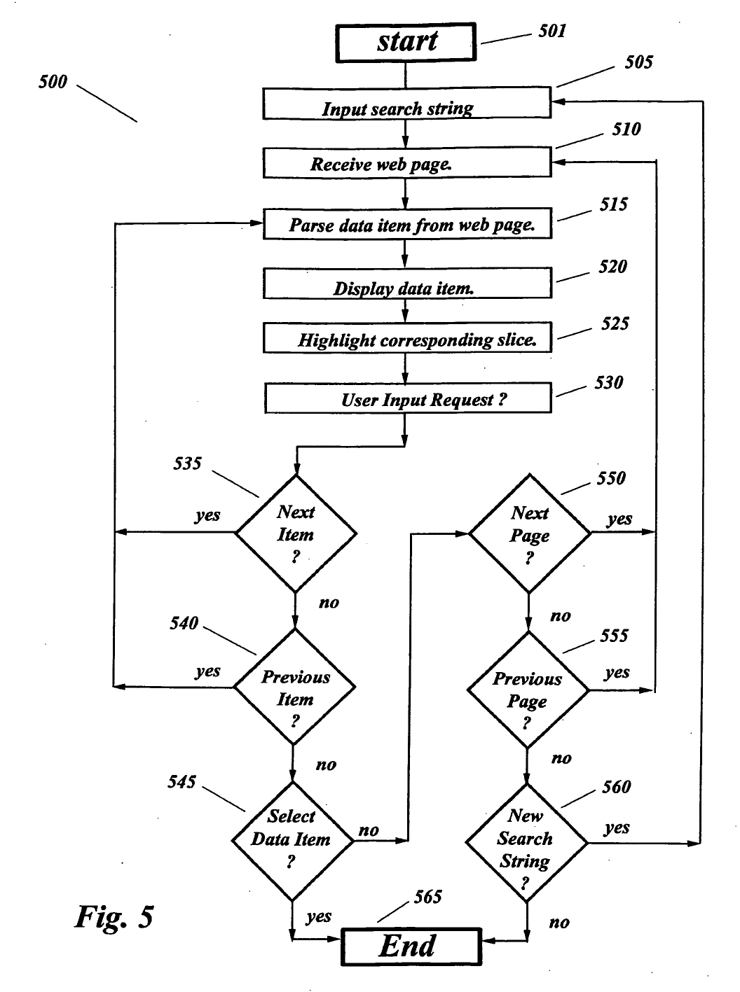

Referring now to FIG. 5, a flow chart 500 detailing a client-based implementation of the user interface of the preferred embodiment is shown. A software program that embodies the flow chart 500 is dependent on the method in which the client application is implemented. As detailed in the description for FIG. 1, the GUI 103 may exist as a web page within a device's 100 web browser, a device specific web browser, or an embedded application with the capability to access databases on the Internet. In the preferred embodiment, the software program may be implemented as a web page within a browser that parses, executes and displays HTML. Such web based interactive program support such as J2ME, JAVA, AJAX, ACTIVE X, FLASH or the like improves client interactive user response for STEPS 520 and 525 as detailed below. In this case, the MID 100 does not require a web page request from the Web server 305 to make display updates. Additionally, User Input Requests (535, 540, 545, 550, 555, and 560) and all display changes (such as 520, 525) typically require web page requests to the Web server 305 without the additional of web based interactive programming support.

In the case where the software program is implemented as a device-specific web browser or an embedded application, then the native platform programming language and support libraries are employed. As with the use of web-based interactive program support as described above, web page requests beyond Step 510 are mitigated and client interactive user response is superior to web page requests (510) and display refresh (520, 525).

The client implementation 500 resides on the mobile Internet device (330, 100). At the start 501, a user inputs a search string 505 to the client, which is a mobile Internet device and which in turn generates a request to a web server. A web page is received 510 in response and the page is parsed 515 such that the next data element (108) is displayed in step 520. As described for FIG. 1, the corresponding selected slice (106) is highlighted at step 525. Steps 520 and 525 result in visible display updates. It will be apparent to one skilled in the art that the position marker discussed herein (106 and alternatively 207, 208, 209), are simply examples of graphical implementation and in no way restricts the scope of the present invention.

Next, in step 530 when a user request is input to the interface, the type of the request is determined. If the request relates to changing the selected data item to the next item 535 in the search results or the previous data item 540 in the search results, then program flow returns to step 515, which parses the correct data element from the current web page. If the data item cannot be retrieved from the current web page, then the user input is first tested to determine if the data item is selected 545 or clicked through. In this case, program control terminates 565 as consequently the corresponding web page for the associated data element's link is loaded.

If a data item is not selected 545, then the user input request is tested to determine if the next page 550 in the search results or the previous page 555 contains the data element that is to be displayed next 520. If both of these tests fail, then the user input request is tested to determine if it is a new search string 560. If so, program control returns to 505 and the process is repeated for that new string. If not, then the program terminates 565. It should be apparent to one skilled in the art that this program flow chart 500 is only one of many variations for receiving user input, receiving and parsing web pages, and parsing the data for display of each data element in response to the user's input.

While a plurality of preferred exemplary embodiments have been presented in the foregoing detailed description, it should be understood that a vast number of variations exist, and these preferred exemplary embodiments are merely representative examples, and are not intended to limit the scope, applicability or configuration of the invention in any way. Rather, the foregoing detailed description provides those of ordinary skill in the art with a convenient guide for implementation of the invention, and contemplates that various changes in the functions and arrangements of the described embodiments may be made without departing from the spirit and scope of the invention defined by the claims thereto.

What is claimed is:

1. A display and selection interface apparatus comprising:
a display surface;
a data display box, rendered on said display surface, for viewing a first portion of data selected from a data body;
a relative position marker, rendered on said display surface, for indicating the position of said first portion of data relative to the entirety of said data body;
a selection device for moving said relative position marker from a first position to a second position, and in coordination therewith, causing the replacement of said first portion of data with a second portion of data located relative to the entirety of said data body at the second position indicated by said relative position marker; and
said data body and said first and second portions of data of a type selected from:
text, graphics, files, or internet search results,
said interface comprising the same elements regardless of the type of said data body and said first and second portions of data.

2. The apparatus of claim 1, wherein said selection device is a click wheel.

3. The apparatus of claim 1, wherein said relative position marker is a pie chart, whereby relative potion is indicated by highlighting a wedge of said pie chart.

4. The apparatus of claim 3, wherein relative position ranges from a first position being a wedge at a vertical, topmost position on said pie chart and proceeding in a clockwise direction toward a last position.

5. The apparatus of claim 1 wherein said portion of data displayed in said data display box is a currently selected portion of data, said interface further comprising a previous data box for displaying data located relatively immediately before said currently selected portion of data in said data body, and a next data box for displaying data located relatively immediately following said currently selected portion of data in said data body.

6. The apparatus of claim 1 wherein said data body and said first and second portions of data are text and internet search results.

7. The apparatus of claim 1 wherein said data body and said first and second portions of data are text and audio files.

8. The apparatus of claim 1 wherein said apparatus is a portion of and integrated into a cellular telephone.

9. The apparatus of claim 1 wherein said apparatus is a portion of and integrated into a personal digital assistant.

10. The apparatus of claim wherein said apparatus forms a portion of a web browser application.

11. A portable, hand-held apparatus having a display and selection interface comprising:
a display surface;
a data display box, rendered on said display surface, for viewing a first portion of data selected from a data body;
a relative position marker, in the form of a pie chart, rendered on said display surface, for indicating the position of said first portion of data relative to the entirety of said data body based on a position of a highlighted wedge of said pie chart;
a click wheel selection device for moving said relative position marker from a first position to a second position, and in coordination therewith, causing the replacement of said first portion of data with a second portion of data located relative to the entirety of said data body at the second position indicated by said relative position marker; and
said data body and said first and second portions of data of a type selected from:
text, graphics, files, or internet search results,
said interface comprising the same elements regardless of the type of said data body and said first and second portions of data.

12. The apparatus of claim 11, wherein relative position ranges from a first position being a wedge at a vertical, topmost position on said pie chart and proceeding in a clockwise direction toward a last position.

13. The apparatus of claim 11 wherein said data body and said first and second portions of data are text and internet search results.

14. The apparatus of claim 11 wherein said data body and said first and second portions of data are text and audio files.

15. The apparatus of claim 11 wherein said apparatus is a cellular telephone.

16. The apparatus of claim 11 wherein said apparatus is a personal digital assistant.

17. A method of providing an indication of the position of a displayed data item relative to a body of such data items, comprising:
inputting a search string into a web browser interface of a web browser program operating on a portable display device;
wirelessly transmitting said search string to a web server;
wirelessly receiving search results from said web server, said result including at least two data items;
parsing said search results;
determining the total number of data items received from said web server in response to said search;
displaying a relative position marker in the form of a chart having a number of discrete elements representing the total number of data items received from said web server in response to said search;
receiving a selection of a data item to be displayed on said portable display device;
determining the position of said selected data item relative to the body of such data items; and
indicating on said relative position marker the determined position of said selected data item relative to the body of such data items by highlighting a corresponding one of said elements.

18. The method of claim 17 wherein said chart comprises a pie chart, and said elements comprises wedges of said pie chart.

19. The method of claim 18, wherein relative position ranges from a first position being a wedge at a vertical, topmost position on said pie chart and proceeding in a clockwise direction toward a last position.

20. The method of claim 17, wherein said chart comprises regions of said display such that an empty first region indicates that the displayed data items is located at the start of the body of data items and an empty second region indicates that the displayed data items is located at the end of the body of data items.
